(19) United States
(12) Patent Application Publication
(10) Pub. No.: US 2017/0335440 A1
(43) Pub. Date: Nov. 23, 2017

(54) FATIGUE-RESISTANT BEARING STEEL

(71) Applicant: Aktiebolaget SKF, Goteborg (SE)

(72) Inventors: Mohamed Sherif, Hilversum (NL); Yuri Kadin, Nieuwegein (NL)

(21) Appl. No.: 15/369,991

(22) Filed: Dec. 6, 2016

(30) Foreign Application Priority Data
Dec. 14, 2015 (GB) 1521947.0

(51) Int. Cl. C22C 38/52; C22C 38/00; F16C 33/62; C22C 38/02; C22C 38/46; C22C 38/42; C22C 38/06; C22C 38/04; C22C 38/44; C22C 38/48

(52) U.S. Cl. CPC C22C 38/52; C22C 38/44; C22C 38/002; F16C 33/62; C22C 38/48; C22C 38/46; C22C 38/001; C22C 38/42; C22C 38/06; C22C 38/04; C22C 38/02; F16C 2204/66; F16C 2204/72

(57) ABSTRACT

A steel alloy for a bearing, the alloy having a composition that provides: from 0.8 to 1.0 wt. % carbon, from 0.1 to 0.5 wt. % silicon, from 0.2 to 0.9 wt. % manganese, from 2.0 to 3.3 wt. % chromium, from 0 to 0.4 wt. % molybdenum, from 0 to 0.2 wt. % cobalt, from 0 to 0.2 wt. % iridium, from 0 to 0.2 wt. % rhenium, from 0 to 0.2 wt. % vanadium, from 0 to 0.1 wt. % niobium, from 0 to 0.5 wt. % tungsten, from 0 to 0.2 wt. % nickel, from 0 to 0.4 wt. % copper, from 0 to 0.05 wt. % aluminum, from 0 to 150 ppm nitrogen, and the balance iron, together with any unavoidable impurities.

### CROSS REFERENCE TO RELATED APPLICATIONS

This application claims priority to British patent application no. 1521947.0 filed on Dec. 14, 2015, the contents of which are fully incorporated herein by reference.

### FIELD OF THE INVENTION

The present invention relates generally to the field of metallurgy. More specifically, the present invention relates to a steel alloy which is used in the manufacture of bearings.

### BACKGROUND OF THE INVENTION

Bearings are devices that permit constrained relative motion between two parts. Rolling element bearings provide inner and outer raceways and a plurality of rolling elements (for example balls and/or rollers) disposed therebetween. For long-term reliability and performance, it is important that the various elements have a high resistance to rolling contact fatigue, wear and creep.

Conventional techniques for manufacturing metal components involve hot-rolling or hot-forging to form a bar, rod, tube or ring, followed by a soft forming/machining process to obtain the desired near net shape component. Surface-hardening and through-hardening processes are well known and are used to locally increase the hardness of surfaces of finished or semi-finished components so as to improve, for example, wear resistance and fatigue resistance. A number of surface or case hardening processes are known for improving rolling contact fatigue resistance.

A typical hardened bearing steel microstructure is composed of a matrix that often is either bainitic or tempered martensitic, and carbides. The carbides may include cementite particles. For example, in the steel system 100Cr6, they may have the stoichiometry M3C (M=Metal, being mostly Fe). The cementite particles that are found in typical bearing steel hardened microstructures are crucial in bearing applications especially if slip takes place in the bearing contact. In the context of fatigue, however, these particles, albeit relatively very hard and strong and small in size at about 1 μm or less, represent internal micro-notches.

It has been found that the cementite particles can sometimes shear and crack once fatigue bands are formed, and, in addition, may also become amorphous, or cause the formation of amorphous regions in the bearing component, due to the rubbing of the nascent crack surfaces under rolling contact. These forms of microstructural decay appear white once a section of the affected bearing component is investigated metallographically (“white etching areas”).

It is an object of the present invention to address some of the problems associated with the prior art, or at least to provide a commercially useful alternative thereto.

### BRIEF SUMMARY OF THE INVENTION

The present invention provides a steel alloy for a bearing, the alloy having a composition comprising:

from 0.8 to 1.0 wt. % carbon,

from 0.1 to 0.5 wt. % silicon,

from 0.2 to 0.9 wt. % manganese,

from 2.0 to 3.3 wt. % chromium,

from 0 to 0.4 wt. % molybdenum,

from 0 to 0.2 wt. % cobalt,

from 0 to 0.2 wt. % iridium,

from 0 to 0.2 wt. % rhenium,

from 0 to 0.2 wt. % vanadium,

from 0 to 0.1 wt. % niobium,

from 0 to 0.5 wt. % tungsten,

from 0 to 0.2 wt. % nickel,

from 0 to 0.4 wt. % copper,

from 0 to 0.05 wt. % aluminium,

from 0 to 150 ppm nitrogen, and

the balance iron, together with any unavoidable impurities.

The present invention will now be described further. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In the present invention, the steel alloy composition provides from 0.8 to 1.0 wt. % carbon preferably from 0.8 to 0.9 wt. % carbon. In some embodiments, where higher hardness is required, the composition provides from 0.85-0.95 wt. % carbon. In combination with the other alloying elements, this results in the desired microstructure, which includes carbide particles, and resistance to microstructural decay caused by rolling contact fatigue. In particular, the formation of white etching areas is reduced or eliminated by the combination of alloying elements. It is believed that this may be a result of the carbide particles, particularly cementite, and the matrix phases in the final functional microstructure exhibiting higher elastic properties, for example, higher shear modulus, thereby resisting amorphisation. Carbon also acts to lower the temperature at which bainite can be formed, so that a fine structure is achievable. The presence of carbon may result in the retention of carbides and/or carbonitrides during austenitisation, which may act as austenite grain refiners. When the carbon content is higher than 1.0 wt. %, there may be an increase in the propensity of the material to form white etching areas. When the carbon content is lower than 0.8 wt. %, the alloys may have a higher martensite start temperature, which results in difficulties in obtaining bainite-only microstructures with hardness adequate for bearing applications.

The steel alloy composition provides from 0.1 to 0.5 wt. % silicon, preferably from 0.1 to 0.45 wt. % silicon, more preferably from 0.1 to 0.4 wt. % silicon. In combination with the other alloying elements, this results in the desired microstructure with a minimum amount of retained austenite. Silicon has negligible solubility in carbides; particularly at high temperatures where its diffusivity is sufficiently high for it not to be trapped in carbides. Silicon also helps to suppress excessive precipitation of cementite and carbide formation. In addition, silicon stabilises transition carbides and improves the tempering resistance of the steel microstructure. However, too high a silicon content may result in lowering the elastic properties of the matrix. For this reason, the maximum silicon content is 0.5 wt. %.

The steel alloy composition provides from 0.2 to 0.9 wt. % manganese, preferably from 0.35 to 0.8 wt. % manganese, more preferably from 0.4 to 0.6 wt. % manganese. The manganese content is at least 0.2 wt. %, since this, in combination with the other alloying elements, helps to reduce the formation of white etching areas. Manganese also acts to improve hardenability. In addition, manganese acts to increase the stability of austenite relative to ferrite. However, manganese levels above 0.9 wt. % may serve to increase the amount of retained austenite and to decrease the rate of transformation to bainite. This may lead to practical metallurgical issues such as stabilising the retained austenite too much, leading to potential problems with the dimensional stability of the bearing components.

In addition, manganese may reduce the elastic properties of the matrix, for example, lath martensite, but since it enriches the carbides to an extent larger than the matrix, its content in the alloy can be kept at the cited levels. Once dissolved in the carbides, particularly cementite, the carbides are more thermodynamically stable, exhibiting improved elastic properties and better resistance to cracking (shearing) and white etching area formation.

The steel composition provides from 2.0 to 3.3 wt. % chromium, preferably from 2.3 to 3.3 wt. % chromium, more preferably from 2.5 to 3.1 wt. % chromium. The chromium content is at least 2.0 wt. %, since this, in combination with the other alloying elements, helps to reduce the formation of white etching areas. Unlike manganese, chromium may increase the elastic properties of both the matrix and the carbides. At higher levels of chromium, cementite may be partly or largely replaced by the more stable chromium-rich carbide, M7C3. Chromium also acts to increase hardenability and reduce the bainite start temperature. Chromium may also be beneficial in terms of corrosion resistance.

The steel composition may optionally include up to 0.4 wt. % molybdenum, for example from 0.1 to 0.4 wt. % molybdenum, preferably from 0.2 to 0.35 wt. % molybdenum, more preferably from 0.25 to 0.3 wt. % molybdenum. Molybdenum may act to avoid austenite grain boundary embrittlement owing to impurities such as, for example, phosphorus. Molybdenum may also reduce the bainite start temperature and increases hardenability, which is important when the steel is used to manufacture e.g. a large-size bearing ring that requires hardening to a relatively large depth upon quenching from high temperature. The molybdenum content in the alloy is preferably no more than about 0.4 wt. %, otherwise the austenite transformation into bainitic ferrite may cease too early, which can result in significant amounts of austenite being retained in the structure. In other embodiments, where the steel is used to manufacture a relatively small-size bearing ring and where hardenability is less critical, Mo is kept to a minimum, namely a level of 0.1 wt. % or less.

The steel composition may optionally include one or more of: up to 0.2 wt. % cobalt (for example 0.05 to 0.15 wt. % cobalt), up to 0.2 wt. % iridium (for example 0.05 to 0.15 wt. % iridium), up to 0.2 wt. % rhenium (for example 0.05 to 0.15 wt. % rhenium), up to 0.2 wt. % vanadium (for example 0.05 to 0.15 wt. % vanadium), up to 0.1 wt. % niobium (for example 0.05 to 0.10 wt. % niobium) and up to 0.5 wt. % tungsten (for example 0.05 to 0.4 wt. % tungsten). Co, Ir, Re, V, Nb and/or W have surprisingly been found to further improve the microstructure, perhaps by imparting microstructural refinement and/or raising its elastic properties, thereby better resisting the formation of white etching matter during rolling contact.

The steel composition may optionally include up to 0.2 wt. % nickel, for example from 0.05 to 0.1 wt. % nickel. Nickel is, however, preferably absent from the steel alloy.

The steel composition may optionally include up to 0.4 wt. % copper, for example from 0.05 to 0.35 wt. % copper.

The steel composition may optionally include up to 0.05 wt. % aluminium, for example from 0.005 to 0.05 wt. % aluminium, preferably from 0.01 to 0.03 wt. % aluminium. Aluminium may also serve as a deoxidiser. However, the use of aluminium requires stringent steel production controls to ensure cleanliness and this increases the processing costs. Therefore, the steel alloy provides no more than 0.05 wt. % aluminium.

In some embodiments, nitrogen may be added such that the steel alloy provides from 50 to 150 ppm nitrogen, preferably from 75 to 100 ppm nitrogen. The presence of nitrogen may be beneficial for promoting the formation of complex nitrides and/or carbonitrides. In other embodiments, there is no deliberate addition of nitrogen. Nevertheless, the alloy may necessarily still provide at up to 50 ppm nitrogen due to exposure to the atmosphere during melting.

As noted above, the steel composition may optionally include one or more of the following elements:

from 0 to 0.4 wt. % molybdenum (for example 0.05 to 0.5 wt. % molybdenum)

from 0 to 0.2 wt. % cobalt (for example 0.05 to 0.2 wt. % cobalt)

from 0 to 0.2 wt. % iridium (for example 0.05 to 0.2 wt. % iridium)

from 0 to 0.2 wt. % rhenium (for example 0.05 to 0.2 wt. % rhenium)

from 0 to 0.2 wt. % vanadium (for example 0.05 to 0.2 wt. % vanadium)

from 0 to 0.1 wt. % niobium for example 0.05 to 0.10 wt. % niobium)

from 0 to 0.5 wt. % tungsten (for example 0.05 to 0.5 wt. % tungsten)

from 0 to 0.2 wt. % nickel (for example 0.05 to 0.2 wt. % nickel)

from 0 to 0.4 wt. % copper (for example 0.05 to 0.35 wt. % copper)

from 0 to 0.05 wt. % aluminium (for example 0.01 to 0.05 wt. % aluminium)

from 0 to 150 ppm nitrogen (for example 50 to 150 ppm nitrogen)

It will be appreciated that the steel alloy referred to herein may contain unavoidable impurities, although, in total, these are unlikely to exceed 0.3 wt. % of the composition. Preferably, the alloys contain unavoidable impurities in an amount of not more than 0.1 wt. % of the composition, more preferably not more than 0.05 wt. % of the composition. In particular, the steel composition may also include one or more impurity elements. A non-exhaustive list of impurities includes, for example:

from 0 to 0.025 wt. % phosphorous

from 0 to 0.015 wt. % sulphur

from 0 to 0.04 wt. % arsenic

from 0 to 0.075 wt. % tin

from 0 to 0.075 wt. % antimony

from 0 to 0.002 wt. % lead

from 0 to 0.002 wt. % boron

The steel alloy composition preferably provides little or no sulphur, for example from 0 to 0.015 wt. % sulphur.

The steel alloy composition preferably provides little or no phosphorous, for example from 0 to 0.025 wt. % phosphorous.

The steel composition preferably provides 15 ppm oxygen. Oxygen may be present as an impurity. The steel composition preferably provides 30 ppm titanium. Titanium may be present as an impurity. The steel composition preferably provides 20 ppm boron. The steel composition preferably provides 50 ppm calcium. Calcium may be present as an impurity.

Preferably, the maximum content of the combination of one or more of any arsenic, any tin and any antimony is 0.075 wt. %.

In an embodiment, the steel alloy composition provides:

from 0.85 to 0.95 wt. % carbon,

from 0.15 to 0.3 wt. % silicon,

from 0.5 to 0.8 wt. % manganese,

from 2.5 to 2.9 wt. % chromium,

from 0.3 to 0.4 wt. % molybdenum,

from 0.2 to 0.35 wt. % copper,

from 0 to 0.2 wt. % cobalt,

from 0 to 0.2 wt. % iridium,

from 0 to 0.2 wt. % rhenium,

from 0 to 0.2 wt. % vanadium,

from 0 to 0.1 wt. % niobium

from 0 to 0.2 wt. % tungsten,

from 0 to 0.1 wt. % nickel,

from 0 to 0.05 wt. % aluminium,

from 0 to 150 ppm nitrogen, and

the balance iron, together with any unavoidable impurities.

These preferred embodiments describe steel alloys according to the present invention which have been found particularly resistant to microstructural decay caused by rolling contact fatigue. In particular, the formation of white etching areas is reduced or eliminated by the combination of alloying elements.

The steel alloy compositions according to the present invention may consist essentially of the recited elements. It will therefore be appreciated that in addition to those elements that are mandatory other non-specified elements may be present in the composition provided that the essential characteristics of the composition are not materially affected by their presence.

The steel alloy compositions according to the present invention preferably have a microstructure comprising (i) martensite (typically tempered martensite) and/or bainitic ferrite, (ii) carbides and/or carbonitrides, and (iii) optionally some retained austenite. A low level of retained austenite is advantageous in that it improves dimensional stability of a bearing component. The microstructure may further provide nitrides.

The structure of the steel alloys may be determined by conventional microstructural characterisation techniques such as, for example, optical microscopy, TEM, SEM, AP-FIM, and X-ray diffraction, including combinations of two or more of these techniques.

The steel alloy may exhibit high hardness and/or dimensional stability. This means that the steel alloy can usefully find application in the manufacture of, for example, a bearing component such as, for example, a rolling element, a bearing inner ring or a bearing outer ring. The steel alloy is typically a bearing steel alloy.

According to another aspect of the present invention there is provided a bearing component, comprising a steel alloy as herein described. Examples of bearing components where the steel can be used include a rolling element (e.g. balls or cylindrical, tapered, toroidal or spherical rollers), an inner ring, and an outer ring. The present invention also provides a bearing comprising a bearing component as herein described.

The present invention will now be described further with reference to a suitable heat treatment for the steel alloy, provided by way of example.

The steel alloy compositions according to the present invention are typically subjected to a conventional spheroidising-annealing process prior to hardening. A conventional normalising heat treatment process may also be applied prior to spheroidising-annealing. Hardening will usually require at least the partial austenitisation of the microstructure. This may be achieved, for example, by holding the bearing components within the temperature range 850 to 895° C., preferably for durations of from 15 to 120 minutes. Typical prior austenite grain size is less than 20 μm. Some carbides remain undissolved during austenitisation. Such carbides are, for example, M3C (iron-rich) and M7C3 (chromium-rich). Typical carbide size in this case is up to 3 μm, preferably around 1 μm.

Afterwards, the bearing components are typically quenched into a suitable medium, for example, oil (usually used for martensite hardening), or into a salt bath, if bainite transformation is required.

If a martensitic microstructure is required, typically the components are quenched below the MS temperature (MS is the martensite start temperature, which refers to the temperature at which the transformation from austenite to martensite begins on cooling). However, in some cases, especially when processing larger bearing components with thicker sections, the components may be equilibrated at temperatures just above the MS temperature for sufficient duration prior to subsequent quenching for bainite transformation to commence. In any case, the as-quenched, untempered martensite will usually be followed by a tempering step.

Martensitic hardening and tempering may also be achieved via through hardening or surface induction hardening, for example. In such a case, the material would preferably be tough-tempered prior to hardening.

Bainite hardening usually provides the quenching of the austenitised bearing components down to temperatures just above the MS temperature of the austenite matrix. The components may then be held isothermally at temperature for a time, for example, ranging from 10 minutes up to 24 hours per stage. The bainite hardening (transformation) process may provide, for example, one, two or three transformation stages, all carried out at different temperatures. A typical temperature range for a transformation stage is 175 to 270° C. The objective is to optimise the hardness and the overall transformation time. After bainite transformation has ceased, the components are typically cooled to room temperature.

Optionally, the austenitised bearing components may be hardened such that a mixed martensitic-bainitic microstructure is obtained.

Additionally, sub-zero treatment may be applied on the bearing components, which typically is followed by tempering.

Preferably, the hardened bearing components are free or substantially free from retained austenite.

Optionally, the steel alloy or bearing component may be subjected to surface modifications whether thermo-chemical, mechanical, or both. Such processes may be applied to increase the performance of the bearing component. Examples of such processes include carbonitriding and burnishing.

Optionally, the steel alloy or bearing component may be subjected to a surface finishing technique. For example, burnishing—especially for raceways—which may be followed by tempering and air-cooling. Afterwards, the steel alloy or bearing component may be finished by means of hard-turning and/or grinding operations such as lapping and honing.

The burnishing and tempering operations may cause the yield strength of the affected areas to increase dramatically with significant improvement in hardness, compressive residual stress and better resistance to rolling contact fatigue.

### BRIEF DESCRIPTION OF THE SEVERAL VIEWS OF THE DRAWING

The invention will now be described further, by way of example, with reference to the accompanying non-limiting drawings, in which:

FIGS. 1a and 1b show a micrograph of a top surface and a cross-section through a wear scar produced on a test coupon made from Steel A, being an example in accordance with the invention.

FIGS. 2a and 2b show a micrograph of a top surface and a cross-section through a wear scar produced on a steel coupon made from Steel B, being a comparative example.

### DETAILED DESCRIPTION OF THE INVENTION

### Examples

A steel with the chemical composition: (wt. %) 0.84C-0.24Si-0.51Mn-2.92Cr-0.28Mo was used in the present work (Steel A). Chemical analysis of a sample made from Steel A revealed the presence of further elements: (wt. %) 0.003P-0.001S-0.01Ni-0.018Cu-0.029Al-0.004As-0.001Sn, as well as trace amounts of Ti, Pb, Ca, Sb and O. The balance is made of iron together with any unavoidable impurities. Steel A is suitable for use in the production of large-size bearing rings and has high hardenability. The expected Ideal Critical Diameter for the composition is 160.3 mm (see C. F. Jatczak: Hardenability in high carbon steels. Metallurgical Transactions Volume 4:2267-2277, 1973).

As a reference, a known steel with an equivalent level of hardenability was used, having the following composition: (wt. %) 0.96C-0.52Si-0.93Mn-1.86Cr-0.57Mo (Steel B). Chemical analysis of a sample made from Steel B revealed the presence of further elements: (wt. %) 0.003P-0.001S-0.01Ni-0.017Cu-0.029Al-0.003As-0.002Sn, as well as trace amounts of Ti, Pb, Ca, Sb and O. The balance is made of iron together with any unavoidable impurities. The expected Ideal Critical Diameter for the composition is 163.9 mm.

Steel A and Steel B were prepared in an identical manner. Each composition was vacuum induction melted and cast into ingots of 100 kg each, having a thickness of approx. 80 mm. The ingots were homogenised and then annealed, to soften the material, after which blocks were sectioned from the ingots of Steel A and Steel B. The blocks were then hot rolled to produce plates with a thickness of approx. 20 mm. The plates were heat-treated in an identical manner, using conventional processes such as described above, comprising steps of:

normalising;

spheroidising-annealing;

martensitic hardening;

tempering.

Test coupons of each steel were soft-machined from the plates, after the step of spheroidising-annealing. After hardening and tempering, the test coupons were ground and polished and hardness was measured. The measured hardness for Steel A was 61.3 HRC; the measured hardness for Steel B was 62.4 HRC.

The test coupons were subjected to a fretting wear test, in which a hardened steel ball with a diameter of 12.7 mm was pressed against the test coupon surface, without lubrication, whilst oscillating with tangential micro-displacements of 30 μm. The maximum contact pressure between the ball and the test coupon surface (given by the Hertzian distribution) was fixed at 2 GPa. The test was conducted for 15×103 cycles, at an oscillation frequency of 20 Hz and in ambient conditions, without any deliberate heating or cooling.

Due to the slightly lower hardness of Steel A, the coupons made from this material experienced a slightly higher tangential friction force of 110 N during the fretting wear test compared with the 106 N experienced by the coupons made of Steel B.

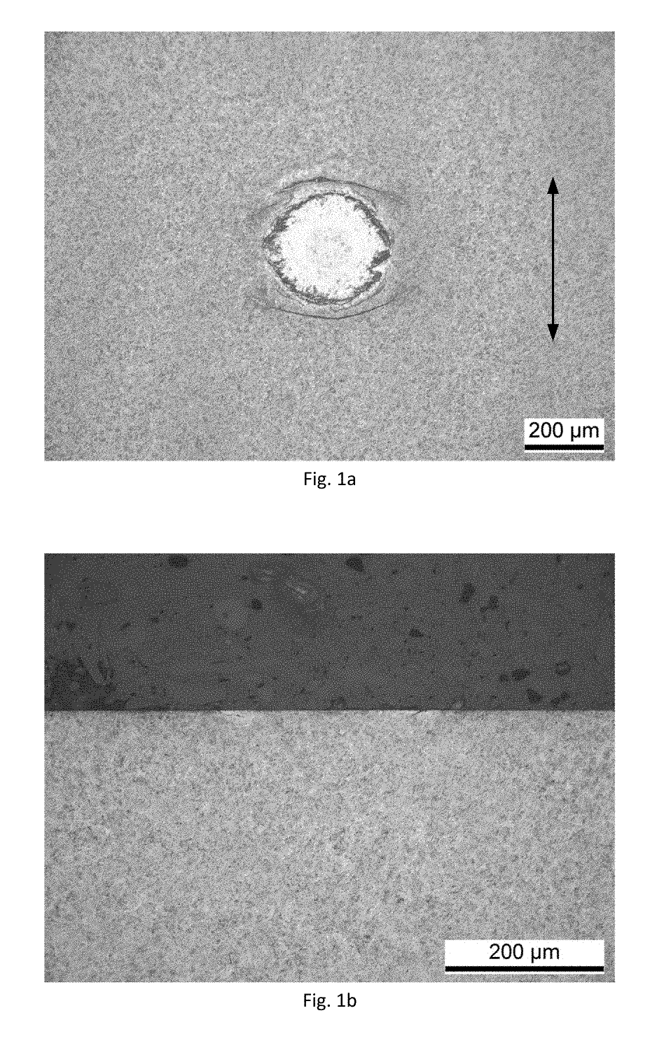

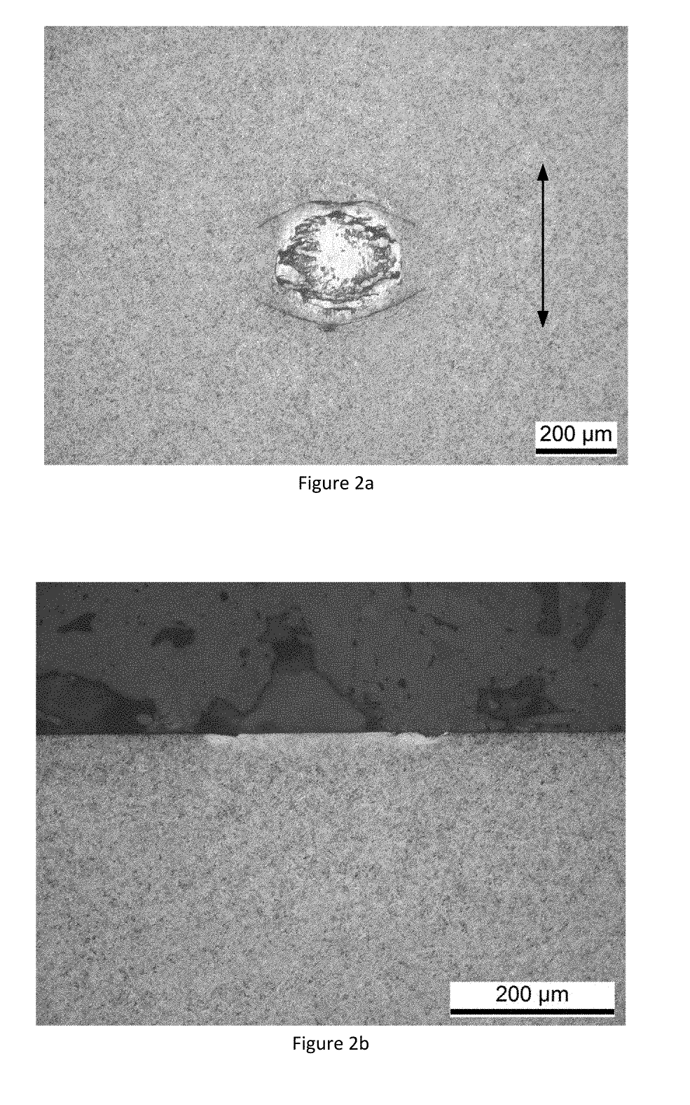

After the test, the resulting wear scars were lightly polished and acid-etched using a 1.5% Nital solution, to reveal white etching areas. A micrograph of the wear scar produced on the top surface of coupons of Steel A and Steel B is shown in FIG. 1a and FIG. 2a respectively. The direction of fretting motion is indicated by the arrows in each figure. Furthermore, each coupon was sectioned along the wear scar in a direction essentially perpendicular to the fretting motion. A micrograph of the sectioned coupons of Steel A and Steel B is shown in FIG. 1b and FIG. 2b respectively.

The fretting test simulates rolling contact fatigue (RCF), which is one of the failure modes in bearings. Frequently, this failure mode is accompanied by the formation of white etching matter in damaged zones, driven by microstructural changes or decay of the steel. The RCF damage is typically associated with the initiation of surface or subsurface cracks which propagate in fatigue and eventually lead to flaking of the material from the raceway. White etching areas are generally localised along subsurface fatigue cracks.

Looking at FIG. 1a and FIG. 2a, it can be seen that the wear scar on both test coupons provides crack formation and white etching matter. However, the white etching matter on the coupon made from Steel A is superficial only. As may be seen from the cut section shown in FIG. 1b, white etching matter is not present in the subsurface of the wear scar.

This is in contrast with the wear scar produced on the test coupon made of Steel B. As may be seen from FIG. 2b, white etching matter is present in the subsurface. Furthermore, loss of material has occurred, possibly due to flaking. The wear scar on the test coupon made from Steel A exhibits barely any material loss.

It may therefore by concluded that the steel in accordance with invention has improved fatigue resistance and is less susceptible to white etching damage.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A steel alloy for a bearing, the alloy having a composition comprising:
from 0.8 to 1.0 wt. % carbon,
from 0.1 to 0.5 wt. % silicon,
from 0.2 to 0.9 wt. % manganese,
from 2.0 to 3.3 wt. % chromium,
from 0 to 0.4 wt. % molybdenum,
from 0 to 0.2 wt. % cobalt,
from 0 to 0.2 wt. % iridium,
from 0 to 0.2 wt. % rhenium,
from 0 to 0.2 wt. % vanadium,
from 0 to 0.1 wt. % niobium,
from 0 to 0.5 wt. % tungsten,
from 0 to 0.2 wt. % nickel,
from 0 to 0.4 wt. % copper,
from 0 to 0.05 wt. % aluminum,
from 0 to 150 ppm nitrogen, and
the balance iron, together with any unavoidable impurities.

2. The steel alloy of claim 1, comprising from 0.8 to 0.9 wt. % carbon.

3. The steel alloy of claim 1, comprising from 0.1 to 0.45 wt. % silicon

4. The steel alloy of claim 1, comprising from 0.35 to 0.8 wt. % manganese.

5. The steel alloy of claim 1, comprising from 2.3 to 3.3 wt. % chromium.

6. The steel alloy of claim 1, comprising from 0.1 to 0.4 wt. % molybdenum.

7. The steel alloy of claim 1, comprising no more than 0.1 wt. % molybdenum.

8. The steel alloy of claim 1, comprising one or more of:
0.05 to 0.2 wt. % cobalt,
0.05 to 0.2 wt. % iridium,
0.05 to 0.2 wt. % rhenium,
0.05 to 0.2 wt. % vanadium,
0.03 to 0.1 wt. % niobium, and/or
0.05 to 0.5 wt. % tungsten.

9. The steel alloy of claim 1, comprising from 0.05 to 0.2 wt. % nickel.

10. The steel alloy of claim 1, comprising from 0.05 to 0.4 wt. % copper.

11. The steel alloy of claim 1, comprising from 0.005 to 0.05 wt. % aluminium.

12. The steel alloy of claim 1, comprising:
from 0.85 to 0.95 wt. % carbon,
from 0.15 to 0.3 wt. % silicon,
from 0.5 to 0.8 wt. % manganese,
from 2.5 to 2.9 wt. % chromium,
from 0.3 to 0.4 wt. % molybdenum,
from 0.2 to 0.35 wt. % copper,
from 0 to 0.2 wt. % cobalt,
from 0 to 0.2 wt. % iridium,
from 0 to 0.2 wt. % rhenium,
from 0 to 0.2 wt. % vanadium,
from 0 to 0.2 wt. % tungsten,
from 0 to 0.1 wt. % nickel,
from 0 to 0.05 wt. % aluminium,
from 0 to 150 ppm nitrogen, and
the balance iron, together with any unavoidable impurities.

13. The steel alloy composition of claim 1, further comprising a microstructure including at least one of (i) martensite, bainitic ferrite, (ii) carbides and carbonitrides, and (iii) optionally retained austenite.

14. A bearing component, comprising:
a steel alloy having;
from 0.8 to 1.0 wt. % carbon,
from 0.1 to 0.5 wt. % silicon,
from 0.2 to 0.9 wt. % manganese,
from 2.0 to 3.3 wt. % chromium,
from 0 to 0.4 wt. % molybdenum,
from 0 to 0.2 wt. % cobalt,
from 0 to 0.2 wt. % iridium,
from 0 to 0.2 wt. % rhenium,
from 0 to 0.2 wt. % vanadium,
from 0 to 0.1 wt. % niobium,
from 0 to 0.5 wt. % tungsten,
from 0 to 0.2 wt. % nickel,
from 0 to 0.4 wt. % copper,
from 0 to 0.05 wt. % aluminum,
from 0 to 150 ppm nitrogen, and
the balance iron, together with any unavoidable impurities, and
one of a rolling element, an inner ring or an outer ring for a bearing.

15. The bearing according to claim 14, further comprising a bearing component.
